(19) United States
(12) Patent Application Publication
(10) Pub. No.: US 2022/0400538 A1
(43) Pub. Date: Dec. 15, 2022

(54) WORKSTATION FOR FILM-PROCESSING PACKAGING MACHINE

(71) Applicant: MULTIVAC SEPP HAGGENMUELLER SE & CO. KG, Wolfertschwenden (DE)

(72) Inventors: Christian NAPRAVNIK, Rosenheim (DE); Markus WAEGELE, Lautrach (DE); Nadine REICHART, Unterjoch/Bad Hindelang (DE); Daniel GROPPER, lllertissen (DE); Christina AMMANN, Waltenhofen (DE)

(73) Assignee: MULTIVAC SEPP HAGGENMUELLER SE & CO. KG, Wolfertschwenden (DE)

(21) Appl. No.: 17/839,424

(22) Filed: Jun. 13, 2022

(30) Foreign Application Priority Data
Jun. 14, 2021 (DE) 102021115294.1
Nov. 10, 2021 (EP) 21207350.6

(51) Int. Cl. H05B 3/22; B65B 47/02; H05B 1/02

(52) U.S. Cl. CPC H05B 3/22; B65B 47/02; H05B 1/023; H05B 2203/013; H05B 2203/003; B65H 2801/81; B65H 2406/351; H05B 2203/017

(57) ABSTRACT

A workstation for a film-processing packaging machine defines a film transport plane in which the packaging film can be transported. In addition, the workstation comprises an electrically operable heating assembly. The latter in turn comprises an electrically conductive planar resistance heating element which in a plane parallel to the film transport plane has dimensions that are greater by a factor of at least 5, preferably at least 10, than in a direction perpendicular to the film transport plane. The resistance heating element is arranged between a heating plate and a clamping plate. The disclosure also relates to a packaging machine with such a workstation and to a method for operating such a workstation.

### CROSS-REFERENCE TO RELATED APPLICATIONS

This application claims foreign priority benefits under 35 U.S.C. § 119(a)-(d) to German patent application number DE 102021115294.1, filed Jun. 14, 2021, and European patent application number EP 21207350.6, filed Nov. 10, 2021, which are incorporated by reference in their entireties.

### TECHNICAL FIELD

The disclosure relates to a workstation for a film-processing packaging machine.

### BACKGROUND

Workstations for film-processing packaging machines often require a way of heating the packaging film and for this purpose dispose of a heating assembly. Tubular heating elements or heating cartridges are typically employed as electrically operable heating elements, as described, for example, in EP 1 403185 A1 for a vacuum chamber machine.

However, while such tubular heating elements are typically durable and reliable, they also have drawbacks. Together with the overall tool, they have inter alia a comparatively high thermal inertia, require a large installation space, make the tools of the workstations correspondingly large and heavy, and the replacement of the tools is labor-intensive.

DE 10 2011 110 973 A1 discloses a heating mat using a carbon nanotube heating varnish which heating mat can be cropped to size, but without disclosing an application in the field of packaging technology. Further heating devices arise from DE 10 2013 004 232 B4 (likewise without reference to packaging technology), DE 10 2014 101 981 A1 (Machine for use in the beverage filling or beverage packaging industry), DE 10 2017 000 439 A1 (Heated filler for filling a liquid or pasty product), DE 20 2011 104 749 U1 (Surface heating system for floors of vehicles), or WO 2007/089118 A1. EP 1 560 751 B1 discloses a resistance heating element for a packaging machine.

### SUMMARY

An object of the present disclosure is to improve a workstation of a film-processing packaging machine while avoiding at least one of the drawbacks explained in the introduction.

This object may be satisfied by a workstation according to the disclosure, by a packaging machine with such a workstation, by a method for operating a workstation according to the disclosure, or by a method of manufacturing a heating element.

The workstation according to the disclosure is characterized in that the heating assembly comprises an electrically conductive planar resistance heating element which in each of two directions spanning a plane preferably parallel to the film transport plane has dimensions that are greater by a factor of at least 100, preferably at least 400, preferably even at least 1000, than in a direction perpendicular to the film transport plane, and that the resistance heating element is arranged between a heating plate and a clamping plate. The planar resistance heating element provides the advantage that the overall height of the heating assembly is comparatively small, but at the same time enables reliable and—if desired—homogeneous heating of a heating surface. Where the term “plate” (both with regard to the heating plate as well as with regard to the clamping plate) within the scope of the disclosure also comprises openworked, overall more grid-like shapes provided with depressions or recesses. With regard to the two directions spanning the plane, it is to be noted that the plane, including the film transport plane, can also be quasi-two-dimensional, i.e., it can also have at least one curvature in one or more spatial directions, or be wavy. For example, it is possible in the context of the disclosure for the film to be drawn along a curved surface of a heating or preheating station. The plane could even be the convex surface of a forming die of a forming station.

The arrangement of the resistance heating element between a heating plate and a clamping plate provides several advantages. Firstly, the heating element is protected in this way from contacting the packaging film or an item to be packaged; and vice versa, the packaged items are also protected from contacting the resistance heating element. This is particularly advantageous when the resistance heating element is formed from a material that is not permitted to come into direct contact with food or comprises such material. Secondly, the arrangement of the resistance heating element between the heating plate and the clamping plate ensures robust mechanical stability.

It is particularly advantageous to have a thermal mass or heat capacity of the heating plate be just as great or at least substantially as great (i.e., with a maximum deviation of 10% or maximum 15%, preferably only maximum 1%) as the thermal mass or heat capacity of the clamping plate. This allows the heating plate and the clamping plate to heat up uniformly, thus preventing thermal stresses and the resulting damage.

It can be expedient to arrange an electrically insulating insulator between the resistance heating element and the heating plate on the one hand and/or between the resistance heating element and the clamping plate on the other hand. In this way, the heating plate or the clamping plate are electrically decoupled from the resistance heating element. Already an insulator with a thickness of 0.05 mm to 1 mm, for example, in the form of a plate, may under certain circumstances be sufficient for reliable electrical insulation, while at the same time impairing the heat transport from the heating element to the heating plate or the clamping plate as little as possible. The insulator can serve as a carrier for the resistance heating element

It is possible in various embodiments that the thickness of the heating assembly from an upper edge of the clamping plate to a lower edge of the heating plate is only 6 to 26 mm, preferably even 15 mm to 25 mm. This is considerably less than conventional heating assemblies, which were often had a thickness of 40 mm or more.

Depending on the intended use and configuration of the workstation, it is conceivable that the resistance heating element has an area of 5,000 mm² to 1,500,000 mm². For example, the resistance heating element or the heating assembly can have an overall extension of 400*400 mm (i.e., 400 mm by 400 mm), even up to a total of 1600*800 mm (i.e., 1600 mm by 800 mm).

In one embodiment of the disclosure, the resistance heating element can comprise at least one layer of a heating varnish. Heating varnish is an electrically conductive resistive varnish that is known as such, but hitherto not for the use in film-processing packaging machines. Heating varnish has the advantage that the resistance heating element and therefore the heating assembly as a whole can be configured to be particularly flat.

For example, it is sufficient to have the layer of the heating varnish have a thickness of only 15 μm to 250 μm, preferably in the range from 30 μm to 150 μm.

According to initial investigations, a heating varnish with a specific resistance of 100 to 1,400 Ω*mm²/m has proven to be advantageous for the use in a workstation according to the disclosure, preferably with a specific resistance in the range from 200 to 1,000 Ω*mm²/m. The higher the specific resistance, the higher the heating output per unit area of the heating element.

The resistance heating element can be applied to a carrier. This increases the stability of the heating assembly. For example, artificial mica (Micanite) or polyetheretherketone (PEEK) can be considered as a material for the carrier. The carrier can be the above-mentioned insulator.

It is conceivable that the carrier is provided with the heating varnish not only on one side, but on two mutually opposite sides. In this way, the heating output of the heating element can be substantially doubled.

Additionally or alternatively, it is conceivable that two or more carriers are provided onto which heating varnish is applied. This also serves to (possibly further) increase the heating output.

If two or more carriers are provided, then a spacer can expediently be arranged in a space between two carriers, possibly in the form of a further electrical insulator, in order to electrically separate two heating elements from one another and, if necessary or if one heating element fails, to be able to operate them independently of one another.

The heating element can have, for example, rectangular or square outer contour in any conceivable embodiment of the disclosure. Alternatively, a circular or elliptical outer contour is also conceivable.

Preferably, a contacting strip, running along the respective side of the heating element and made of a material having a higher electrical conductivity than the heating varnish, is electrically connected to the heating element on two oppositely disposed sides of the resistance heating element. This measure promotes electricity passing through the heating varnish homogeneously and therefore also develops heat homogeneously.

Under certain circumstances, it may be desirable to increase the resistance of the heating element without the thickness of the heating varnish as a whole reducing below a certain value, in order not to impair the stability of the heating varnish. In other situations, it may be desirable to locally increase the heat output supplied by the heating varnish in order to obtain inhomogeneous heat distribution. One solution for both situations is to provide a large number of weak points in the heating varnish, for example, openings or points with locally reduced layer thicknesses of the heating varnish. The denser the local distribution of the weak points, or the more the layer thickness of the heating varnish is locally reduced, the higher the local heat output in the corresponding regions.

As explained, it is conceivable in a variant to distribute such weak points at least substantially uniformly over the entire surface of the heating element. With this measure, the resistance of the heating element is increased overall, having homogeneous heat distribution.

Alternatively, it is conceivable to distribute the weak points non-uniformly over the surface of the heating element in order to be able to generate inhomogeneous heat output by the heating element in a correspondingly selective manner.

In an embodiment of the disclosure, the resistance heating element comprises an electrical flat conductor arranged in a plane and with a meandering profile. This has the advantage of being particularly small in height and thereby providing a compact heating assembly that is correspondingly easy to handle, for example, when the heating assembly is replaced.

Materials having a specific resistance of at least 0.45 Ω*mm²/m, preferably of at least 0.7 Ω*mm²/m, are particularly suitable as flat conductors.

The material of the flat conductor can include, for example, stainless steel, a chromium-nickel alloy, constantan, or graphite. Other materials with comparable mechanical and electrical properties are also conceivable.

The flat conductor preferably has a thickness in the range from approx. 25 μm to 75 μm.

It is expedient to have the flat conductor be arranged between two electrically insulating insulation layers (carriers). As already stated above, this can mechanically stabilize the flat conductor, electrically insulate the heating plate and the clamping plate from the flat conductor, and at the same time prevent any contact between a packaging item and the flat conductor.

For example, artificial mica (Micanite) or PEEK can be considered as the material for such insulation layer or carrier. The flat conductor can be, for example, applied as a layer (e.g., made of stainless steel or other conductive metal) onto the insulation layer/carrier and contoured by milling. If the flat conductor is arranged between two electrically insulating carriers, then, for example, one of the two carriers can comprise webs which come to lie between the tracks of the flat conductor and electrically insulate the tracks from one another in order to prevent short circuits and flashovers between adjacent conductor tracks.

The heating assembly can be configured to generate a (preferably) homogeneous heat distribution over its surface, or to generate an inhomogeneous heat distribution in a selective manner, in which, for example, a higher heating output is provided per unit area in an edge region of the heating assembly than in a central region of the heating assembly.

In one variant, a longer stretch of the flat conductor can be provided per unit area in the edge regions of the resistance heating element than in the central regions of the resistance heating element. This makes it possible to develop more heat in the edge regions, for example, to compensate for heat losses at the edge of the heating element, or to increase the heating output in a selective manner in an edge region of the heating assembly. One possibility for this is a “horseshoe-shaped” profile of the flat conductor at the edge. Additionally or alternatively, the resistance heating element, for example, a flat conductor, can have a smaller cross section in the edge region of the heating assembly than in a central region of the heating assembly, since a smaller cross section means higher electrical resistance and therefore a locally increased heat output.

In general: the flat conductor can therefore preferably have a varying cross section over its profile.

At least one measure is preferably taken to avoid excessive heat generation at one end of the flat conductor. One possible measure is that an end section of the flat conductor has a larger cross section (and thus locally a lower resistance) than a central section of the flat conductor. An alternative or additional measure is to have a contact piece (e.g., angled contact piece) contacting the flat conductor have a larger cross section or a larger coefficient of thermal conductivity than the flat conductor in order to generate less heat at the contact point or to be able to dissipate heat more quickly so that overheating does not occur there. Such an angled contact member or contact piece—with a thickness of, for example, 0.1 mm to 0.8 mm—can be welded to an end region of the flat conductor.

In a further development of the disclosure, an intermediate plate can be arranged between the heating plate and the heating element, where the heating plate on its surface facing the heating element comprises at least one (vacuum) channel which is connected to vacuum openings and covered by the intermediate plate, where the intermediate plate preferably comprises the same material as the heating plate. Such an embodiment is advantageous when the packaging film is to be sucked onto the heating plate by applying a vacuum to the heating plate in order to be heated. Compared to conventionally used heating plates in which vacuum lines were created by drilling and which therefore require a considerable minimum thickness, this further development of the disclosure provides the advantages of easier manufacture and the possibility of reducing the thickness of the heating plate.

It is also conceivable to arrange a temperature sensor on a surface of the heating plate facing the heating element. This arrangement has the advantage of the mechanical protection of the temperature sensor by the heating plate and the very precise measurement of the temperature directly on the heating element.

The insulator can be plate-shaped and have a thickness in the range of 0.1 mm-2 mm, preferably 0.4 mm-1 mm. It offers the advantage of minimizing the risk of electrical flashover, especially under vacuum conditions. Mineral, ceramic or high-temperature plastics, as well as (synthetic) mica (“Micanite”), have proven advantageous as materials for the insulator.

The electrical flat conductor of the heating element can have a thickness in the range of 10 μm-70 μm and/or a width (of a single conductor track of the flat conductor) in the range of 1.5 mm-30 mm.

All electrical and thermal insulators may preferably be heat resistant up to at least 250° C., preferably up to 300° C. or higher.

The heating plate of the heating arrangement can have a thickness of, for example, 4 mm-25 mm.

In the case of a meandering flat conductor, it is conceivable that the ratio of the heating area (i.e., the area occupied by the flat conductor in top view) to the total heating plate area is in the range of 0.1-0.9, i.e., that 10%-90% of the heating plate area is covered by the track of the flat electrical conductor, preferably 30%-70%.

In an edge region of the heating layer, which is, for example, between 15 mm and 75 mm, a power boost with a factor of 1.1 to 2 can optionally be set up in comparison with the heat output per area in an “inner” heating region adjoining the edge region. This has the advantage that the heat output in the edge regions becomes particularly high and heat losses can be compensated there, so that a particularly uniform heat distribution is achieved overall.

One way of achieving such an increase in power in the edge area is to reduce the conductor track width of the flat electrical conductor in the edge area by a proportion of 10%-50% compared with a conductor track width in the central area of the heating plate surface.

A temperature measurement can be performed on the heating arrangement by measuring the resistance of the flat electrical conductor and, if necessary, converting it into a temperature using material- and dimension-dependent constants.

The disclosure also relates to a method of manufacturing an electrical heating element for a work station according to one of the embodiments described above. In this method, the material of the flat conductor is first applied as a layer to a preferably electrically insulating carrier, for example by bonding such a layer to the carrier. The material of the applied layer is contoured into a meandering flat conductor by milling or cutting (for example, by means of a mechanical knife or a laser). Finally, areas of the electrically conductive layer between the tracks of the flat conductor are peeled off, so that in the end the flat electrical conductor remains as a track applied to the carrier. This manufacturing process has the advantage that, on the one hand, the layer is considerably easier to handle than a flat conductor already cut into a thin track. On the other hand, the contouring of the flat conductor track only on the carrier ensures that the course of the flat conductor can be precisely predetermined.

The material for the layer of the flat conductor can be, for example, stainless steel or another conductive metal.

The disclosure also relates to a packaging machine with a workstation according to one of the embodiments described above. Such a film-processing packaging machine can be configured, for example, as a tray sealer, as a chamber machine (including chamber belt machines), or as a deep-drawing packaging machine.

The disclosure also relates to a method for operating a workstation of a film-processing packaging machine according to one of the embodiments described above. In this method, the heating plate of the workstation is made to contact the packaging film intermittently. The method is characterized in that the heating element is first supplied with a current pulse at least over a defined time interval prior to each contact between the heating plate and the packaging film to increase the temperature of the heating plate. This has considerable advantages over a conventional continuous supply of current to a heating element during the operation of the workstation. Because the disclosure enables a lower mean temperature than conventional methods and therefore saves energy.

It is conceivable in a further development that the temperature of the heating plate is kept constant at least temporarily during the contact between the heating plate and the packaging film. This can serve to ensure a predetermined quality of the sealing seam.

The heating assembly can be operated at a voltage of over 300V, preferably up to 500V. A current limit can be provided and configured to limit the maximum current to e.g., 15 A or 20 A.

### BRIEF DESCRIPTION OF THE DRAWINGS

The disclosure shall be explained in more detail below on the basis of embodiments, where in detail:

FIG. 1 shows a first embodiment of a packaging machine according to the disclosure in the form of a tray sealer;

FIG. 2 shows a second embodiment of a packaging machine according to the disclosure in the form of a deep-drawing packaging machine;

FIG. 3 shows a vertical sectional view through an embodiment of a heating assembly;

FIG. 4 shows a top view onto an embodiment of a heating assembly;

FIG. 5 shows a top view onto a further embodiment of a heating assembly;

FIG. 6 shows a perspective view of a detail of the heating assembly according to FIG. 5;

FIG. 7 shows a vertical sectional view through the embodiment according to FIG. 5;

FIG. 8 shows a perspective view of a further embodiment of a heating assembly;

FIG. 9 shows a perspective view of a further embodiment of a heating assembly;

FIG. 10 shows a top view onto a flat conductor from the embodiment according to FIG. 9;

FIG. 11 shows a temperature-time diagram;

FIG. 12 shows a further temperature-time diagram;

FIG. 13 shows a vertical sectional view through an embodiment of a heating assembly with a flat conductor;

FIG. 14 shows an end region of the flat conductor; and

FIG. 15 shows a further detail of an embodiment of the heating assembly with a flat conductor.

FIG. 16 shows a perspective view of a further embodiment of a flat conductor.

FIG. 17 shows a vertical section through a further embodiment of the heating arrangement with a flat conductor, and

FIG. 18 shows a perspective view of a section of the heating arrangement.

Same components are provided with the same or corresponding reference characters throughout the figures.

### DETAILED DESCRIPTION

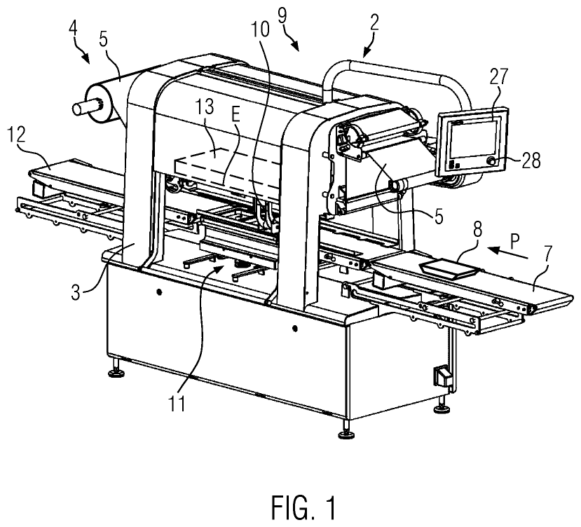

FIG. 1 shows a first embodiment of a packaging machine which in the present embodiment is a tray sealing machine (tray sealer). Packaging machine 2 comprises a frame 3 which can carry a supply roll 4 of a packaging film or top film 5, respectively. Packaging machine 2 also comprises a supply belt 7, by way of which filled, but at this point in time still unclosed, trays 8 can be supplied to a closing station 9 as a workstation of packaging machine 2. Trays 8 can be relocated to closing station 9 in a direction of production P by way of a gripper device 10 and closed there with top film 5 supplied from above, for example, by sealing top film 5 to trays 8. For this purpose, closing station 9 can comprise a sealing tool 11. The sealed and therefore finished packagings can be relocated from closing station 9 to a discharge belt 12 via gripper device 10. Workstation (closing station) 9 comprises a heating assembly 13 for heating or sealing packaging film 5. A display 27 is arranged on packaging machine 2. It disposes of controls 28.

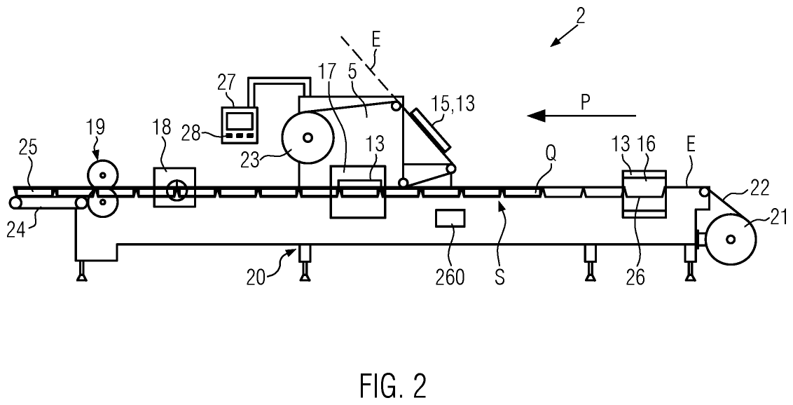

FIG. 2 shows a second embodiment of a packaging machine 2 in the form of a deep-drawing packaging machine. Deep-drawing packaging machine 2 comprises a forming station 16, a sealing station 17, a transverse cutting device 4 in the form of a film punch 18, and a longitudinal cutting device 19 which are arranged in a direction of transport or production P in this order on a machine frame 20. Disposed on the input side on machine frame 20 is a supply roller 21 from which a packaging film or film web 22 is drawn off. Provided in the region of sealing station 17 is a material storage 23 from which a further packaging film (top film) 5 is drawn off. The top film can be preheated from an optional workstation in the form of a preheating station 15 before it is supplied to sealing station 17. Provided on the outlet side on deep-drawing packaging machine 2 is a discharge device 24 in the form of a conveyor belt with which finished, separated packagings 25 are transported away. Furthermore, deep-drawing packaging machine 2 comprises an advancement device which grips film web 22 and transports it onward in direction of production P intermittently per main work cycle. The advancement device can be implemented, for example, by clip chains arranged on both sides.

In the embodiment shown, forming station 16 is configured as a deep-drawing station in which trays 26 are formed into base film 22 by deep drawing. Forming station 16 can be configured such that several trays 26 are formed adjacent to one another in the direction perpendicular to direction of production P. Provided in direction of production P downstream of forming station 16 is an insertion section S in which trays 26 formed in film web 22 are filled with products Q by way of a filler 14 provided in addition to packaging machine 2.

Transverse cutting device 18 is configured as a film punch which severs film web 22 and top film 5 in a direction transverse to direction of production P between adjacent trays 26. Film punch 18 operates in such a way that film web 22 is cut open not over the entire width, but is instead not severed at least in one edge region. This enables the controlled onward transport through the advancement device.

In the embodiment shown, longitudinal cutting device 19 is configured as a knife assembly with several rotating circular knives with which film web 22 and top film 5 are severed between adjacent trays 26 and at the lateral edge of film web 22 so that individual packagings 25 are present downstream of longitudinal cutting device 19.

Deep-drawing packaging machine 2 furthermore comprises a control device 260. Its task is to control and monitor the processes running in deep-drawing packaging machine 2. A display device 27 with control elements 28 presently arranged on deep-drawing packaging machine 2 is used to visualize or influence the process sequences in deep-drawing packaging machine 2 to or by an operator.

Each of workstations 16 and 17, i.e., forming station 16 and sealing station 17, as well as optionally provided preheating station 15, comprises a heating assembly 13 for heating respective packaging film 5, 22. In addition, each of workstations 9, 15, 16, 17 defines a film transport plane E in which packaging film 5, 22 is located in respective workstation 9, 15, 16, 17, see FIGS. 1 and 2 in this regard.

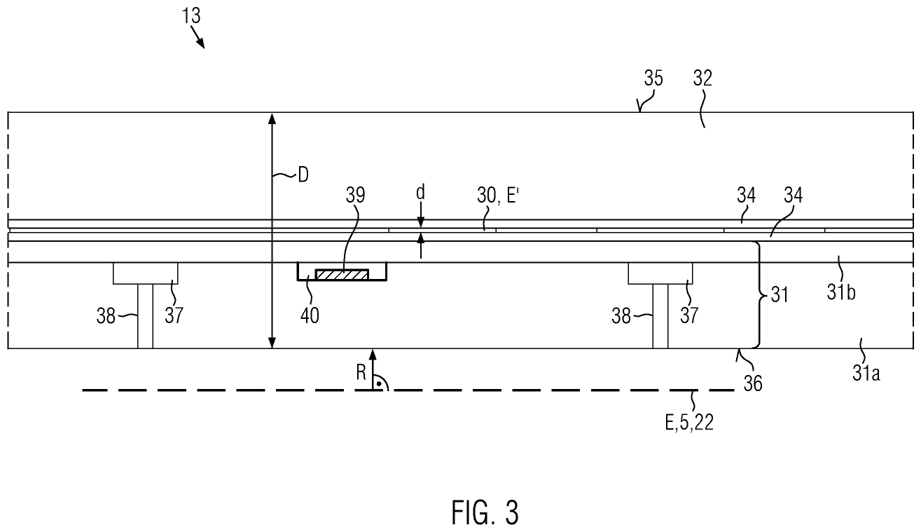

FIG. 3 shows a horizontal sectional view through an embodiment of a heating assembly 13 in a workstation 9, 15, 16, 17 according to the disclosure. Schematically indicated is film transport plane E in which respective packaging film 5, 22 is located.

Heating assembly 13 can be operated electrically. As a central element, it comprises an electrically conductive planar resistance heating element 30 which is arranged in a plane E′ that is parallel or substantially parallel to film transport plane E. In this plane E′, which is parallel to film transport plane E, the resistance heating element in each of the two directions spanning plane E′ has a dimension L1, L2 that is greater by a factor of at least 100, preferably of at least 400, or even at least 1000 than the thickness or dimension d in a direction R perpendicular to film transport plane E.

Heating assembly 13 further comprises a heating plate 31 on the side facing packaging film 5, 22 as well as a clamping plate 32 on its oppositely disposed side so that resistance heating element 30 is arranged between heating plate 31 and clamping plate 32.

In the present embodiment, heating plate 31 comprises an outer heating plate 31a and an intermediate plate 31b. Heating plate 31 and clamping plate 32 comprise at least largely corresponding thermal masses and for this purpose can be made, for example, from the same material and have the same thickness. This has the advantage that thermal stresses do not arise when heating assembly 13 is heated by way of resistance heating element 30. Arranged between resistance heating element 30 and heating plate 31 on the one hand and between resistance heating element 30 and clamping plate 32 on the other hand can be a respective electrically insulating insulation layer or insulator 34, respectively. Insulators 34 presently being plate-shaped, which can also serve as carriers for the heating varnish, each have a thickness of only about 0.1 mm to 2 mm, preferably 0.1 mm to 1 mm. A thickness D of the entire heating assembly from an upper edge 35 of clamping plate 32 to a lower edge 36 of heating plate 31 is only about 8 mm to 25 mm in this embodiment and therefore considerably less than in conventional heating assemblies. The thermal masses of heating plate 31 and clamping plate 32 may be exactly equal to each other. However, it may be sufficient if the smaller thermal mass is up to a maximum of 10% smaller than the larger thermal mass of the two plates, preferably up to a maximum of 5%, even more preferably up to a maximum of 1%.

Vacuum channels 37 run transverse across heating assembly 13 on a side of outer heating plate 31a facing intermediate plate 31b. They can be, for example, milled into the surface of outer heating plate 31a and subsequently covered by intermediate plate 31b which is considerably easier to manufacture than perforating a heating plate 31 with bores. Vacuum openings 38 run, for example, with regular spacing between vacuum channels 37 and lower edge 36 of heating plate 31, i.e., the surface of heating plate 31 facing packaging film 5, 22. By applying a vacuum generated by a vacuum source (not shown) to vacuum channels 37 and correspondingly to vacuum openings 38, packaging film 5, 22 can be sucked onto surface 36 of heating plate 31 so that the film can be heated comparatively quickly by thermal conduction.

A temperature sensor 39 can furthermore optionally be located on the side of outer heating plate 31a facing intermediate plate 31b, for example, in a recess 40 provided in addition to vacuum channels 37 in outer heating plate 31a which is likewise covered by intermediate plate 31b. It can be advantageous to have temperature sensor 39 be arranged approximately at the center in heating assembly 13.

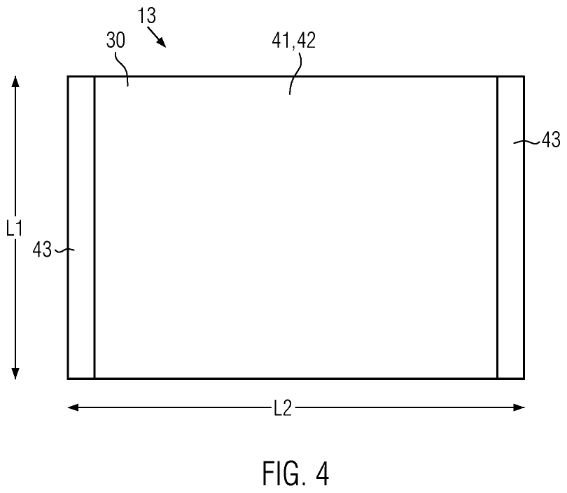

FIG. 4 shows a top view onto an embodiment of an electrically conductive resistance heating element 30 for heating assembly 13 which can be arranged between the two insulators 34. In this embodiment, resistance heating element 30 may comprise a layer 41 of electrically conductive heating varnish 42. The resistance heating element 30 can have an area of, for example, 5,000 mm² to 1,000,000 mm². In the present embodiment, resistance heating element 30 has a rectangular outer contour with outer dimensions L2, L2 parallel to film transport plane E, where L1 and L2 are each greater by a factor of at least 5, preferably at least 10, than thickness d of resistance heating element 30 in a direction perpendicular to film transport plane E.

A contacting strip 43 each is provided on two sides of resistance heating element 30 that are in a top view disposed opposite to one another and is connected to heating varnish 42 and comprises material having a higher electrical conductivity than heating varnish 42. Heating varnish 42 itself can have a thickness, for example, of 25 μm to 250 μm and a specific electrical resistance of 100 to 1,400 Ω*mm²/m, preferably from 200 to 1,000 Ω*mm²/m. When a voltage is applied to two oppositely disposed contacting strips 43, the higher electrical conductivity of contacting strips 43 ensures that a current flows over the entire width of resistance heating element 30 or entire layer 41 of heating varnish 42, which leads to homogeneous heat distribution.

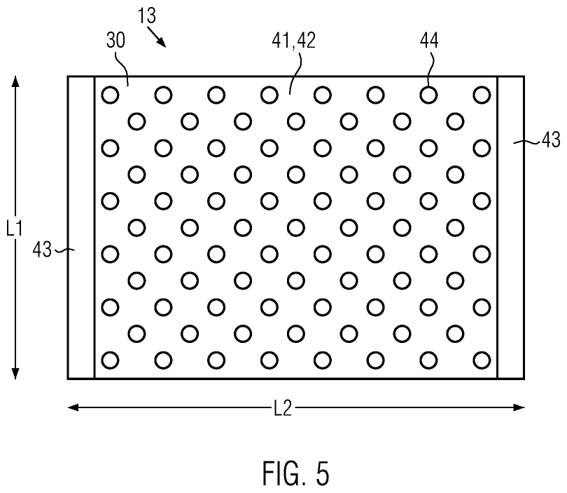

FIG. 5 shows a different embodiment of a resistance heating element 30. It also comprises a two-dimensional layer 41 of electrically conductive heating varnish 42. In order to increase the electrical resistance and therefore the heating output of heating element 30, however, a plurality of weak points 44 are provided in this embodiment in layer 41 of heating varnish 4. In this embodiment, weak points 44 are distributed in a regular pattern over the surface of heating varnish 42. In other embodiments, however, weak points 44 can also be distributed locally in a non-homogeneous manner. Weak points 44 can each consist of a weakening of the material thickness of layer 41 or even of openings or recesses in layer 41.

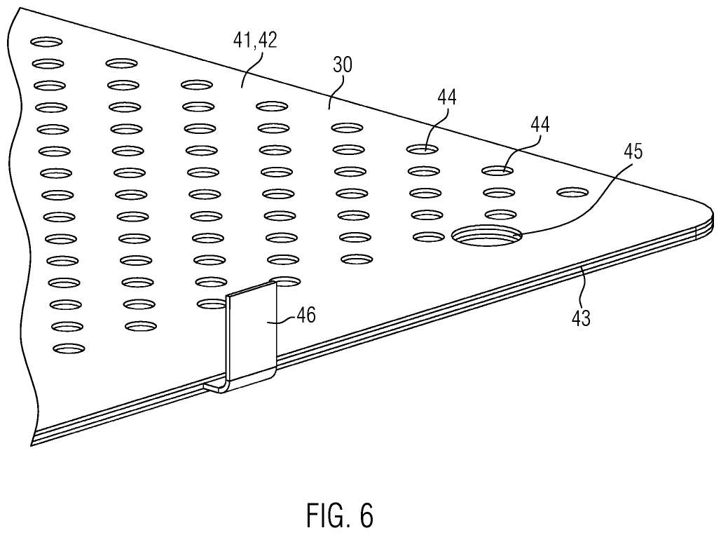

FIG. 6 shows a perspective view of resistance heating element 30 according to FIG. 5. FIG. 6 shows that heating element 30 has an electrically insulating, in the present example plate-shaped spacer 45, for example, comprising artificial mica material. Spacer 45 is disposed on one side or—as in the present embodiment—on both sides of a layer 41 of heating varnish 42. An electrical contact 46, which is electrically connected to contact strip 43, is led out of the assembly to the exterior.

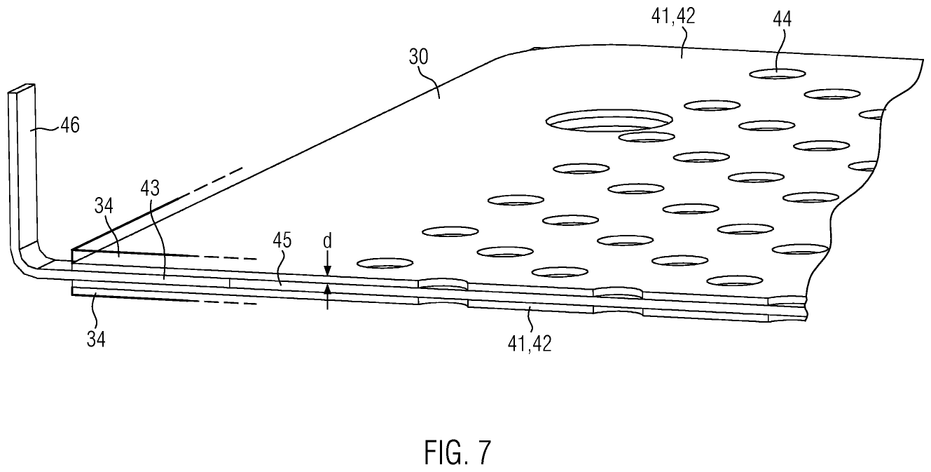

FIG. 7 shows a vertical sectional view through the embodiment according to FIGS. 5 and 6. In comparison with FIG. 6, it can presently be seen even more clearly how the electrical contact 46 is connected to contacting strip 43 which in turn can be configured to be flush with spacer 45. A layer 41 of heating varnish 42 is located on each side of spacer 45. In this embodiment, weak points 44 are configured as holes or openings 44 in layer 41 of heating varnish 42, i.e., they extend in depth over entire thickness d of layer 41. Alternatively, it would be conceivable that weak points 44 consist only of a local reduction in thickness d of layer 41. For reasons of design, holes or openings 44 can also be formed in an insulator 34 which carries respective heating varnish layer 41 and which presently serves as a carrier.

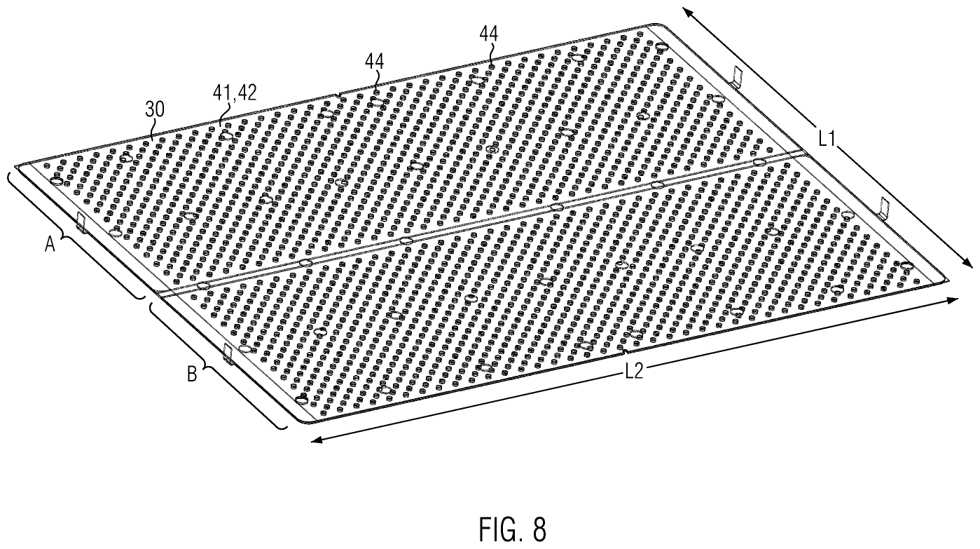

FIG. 8 shows a perspective illustration of a further embodiment of a resistance heating element 30. In this embodiment, two electrically separated regions A, B are provided, each comprising a layer 41 of a heating varnish 42, but which can be electrically operated parallel to one another or even independently of one another.

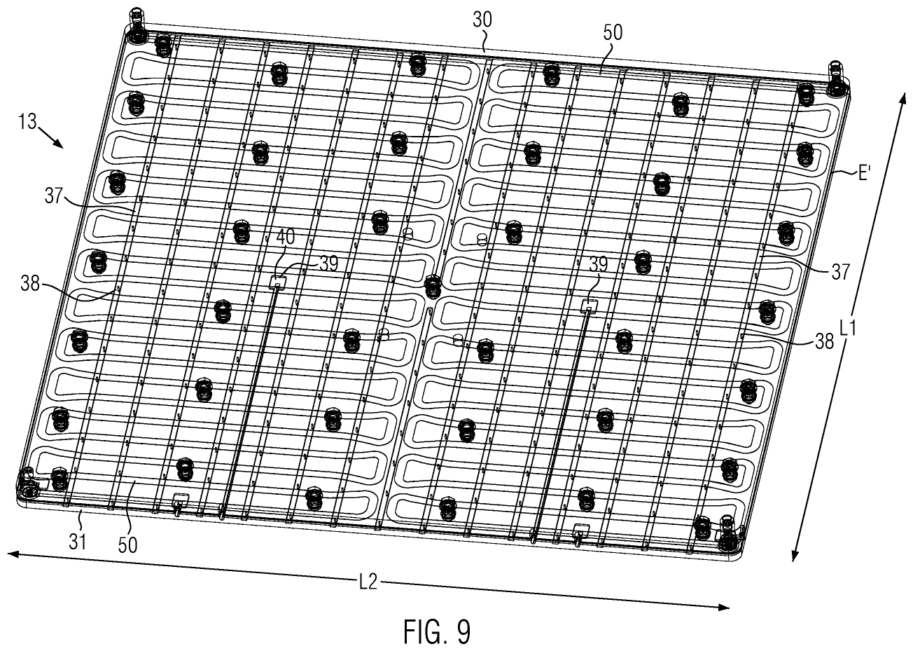

FIG. 9 shows a further embodiment of a resistance heating element 30 for use in a workstation 9, 15, 16, 17 or packaging machine 2 according to the disclosure. In this embodiment, resistance heating element 30 has an electrical flat conductor 50 located in plane E′ and having a meandering profile. In the present embodiment, two such electrical flat conductors 50 are (optionally) provided and each occupy approximately half the area of heating assembly 13. Vacuum channels 37 and vacuum openings 38 in heating plate 31 can also be seen in FIG. 9, as well as two temperature sensors 39 in respective recesses 40 in heating plate 31. Clamping plate 32 is not shown for the sake of clarity.

Flat conductor 50 can comprise as the material, for example, stainless steel, or a chromium-nickel alloy. Flat conductor 50 is characterized in that its conductor track thickness is significantly less than the conductor track width.

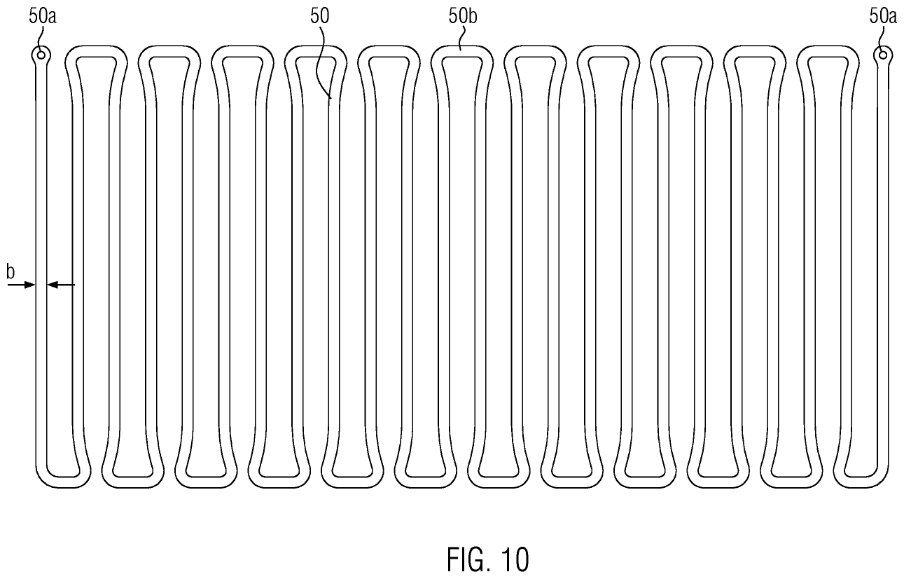

FIG. 10 shows electrical flat conductor 50 as such. The conductor track width of flat conductor 50 is denoted by b, thickness d of flat conductor 50 arises from FIG. 3. FIG. 10 shows that flat conductor 50 has a varying cross section over its profile. In particular, a cross section of end sections 50a of flat conductor 50 is larger than the cross section of central sections 50b of flat conductor 50 in order to counteract overheating at two end regions 50a.

In the embodiment according to FIGS. 9 and 10, the heating output generated by electrical flat conductor 50 is increased in the edge regions of heating element 30 as compared to central regions. This is achieved in that a longer stretch of heating conductor 50 per unit area extends in the edge regions (in FIG. 10: at the upper and lower edge region) than in the central regions. In the present embodiment, this is achieved in that flat conductor 50 is not only bent over to a U-shape at the edges of heating element 30, but presently rather to a “horseshoe” shape. With the increased heating output at the edges of heating element 30, increased heat losses arising there can be compensated for, at least in part.

In comparison to conventional heating assemblies, heating assembly 13 according to the disclosure not only provides advantages with regard to its compactness but also with regard to an overall comparatively low heat capacity. This in turn provides the advantage that heating assembly 13 in workstation 9, 15, 16, 17 according to the disclosure can be operated considerably more dynamically than conventional heating assemblies.

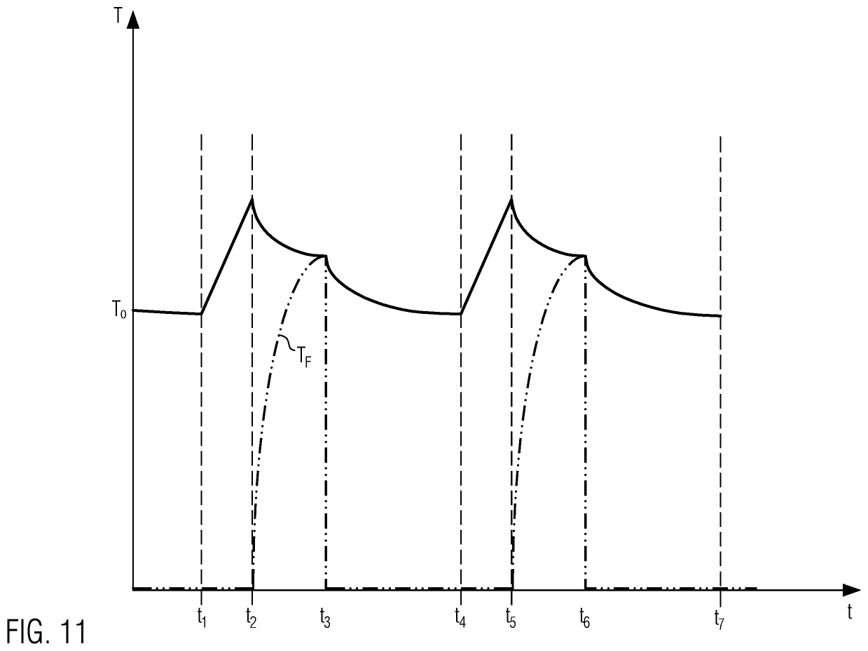

Specifically, a control device 260 of packaging machine 2 can be configured to control the heating assembly in an intermittently operating workstation 9, 15, 16, 17 in such a way that heating plate 31 is selectively heated precisely prior to contact with packaging film 5, 22, in particular by applying a respective current pulse to resistance heating element 30. In control device 260 of packaging machine 2, the point in time at which packaging film 5, 22 comes into contact with heating plate 31 is known from corresponding process parameters. FIG. 11 shows by way of example how temperature T of heating plate 31 (solid line) and temperature T_{F} of the film (dash-dotted line) change over the course of time t. Starting from a starting value To of temperature T, the heating of heating plate 31 by way of resistance heating element 30 begins at point in time t1 until a point in time t2. Temperature T_{F} of film 5, 22 which comes into contact with heating plate 31 at point in time t2 increases; at the same time, temperature T of the heating plate drops exponentially. At point in time t3, the contact between packaging film 5, 22 and heating plate 31 ends. Heating plate 31 continues to cool down when the current pulse has ended at this point in time until the cycle starts again at point in time t4.

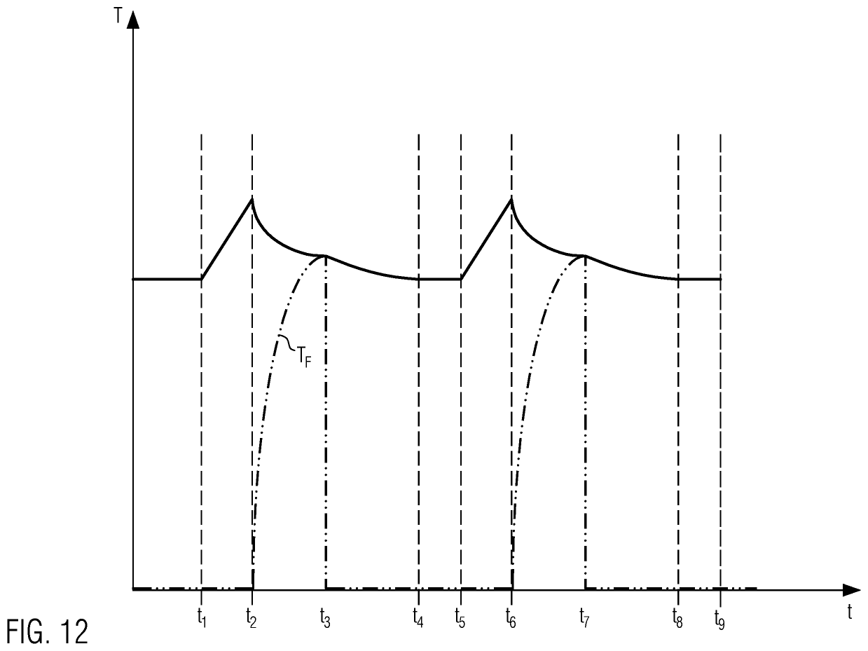

FIG. 12 shows a variant of temperature profile T over time t The only difference to the variant according to FIG. 11 is that, after heating plate 31 has cooled down between points in time t4 and t5, the temperature of the heating plate is kept at a constant level until a new heating cycle begins at point in time t5. Temperature T of the heating plate is kept constant by applying a current to the resistance heating element, the current strength of which is less than the strength of the current pulse applied between points in time t1 and t2 or between points in time t5 and t6.

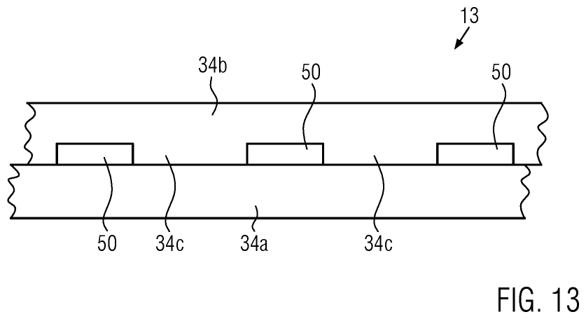

FIG. 13 shows a vertical sectional view through an embodiment of heating assembly 13 with a flat conductor 50. In this embodiment, flat conductor 50 is applied to a first carrier 34a, for example, a carrier 34a made of Micanite. For this purpose, flat conductor 50 can be laid down or applied as a layer and given its contour by milling. A second insulating carrier 34b accommodates flat conductor 50 between itself and first carrier 34a. Second carrier 34b quasi forms a “cover” and can also be made, for example, of Micanite. In the embodiment shown, second carrier 34b comprises webs 34c which come to lie between the tracks of flat conductor 50 and prevent an electrical flashover between the adjacent tracks of flat conductor 50.

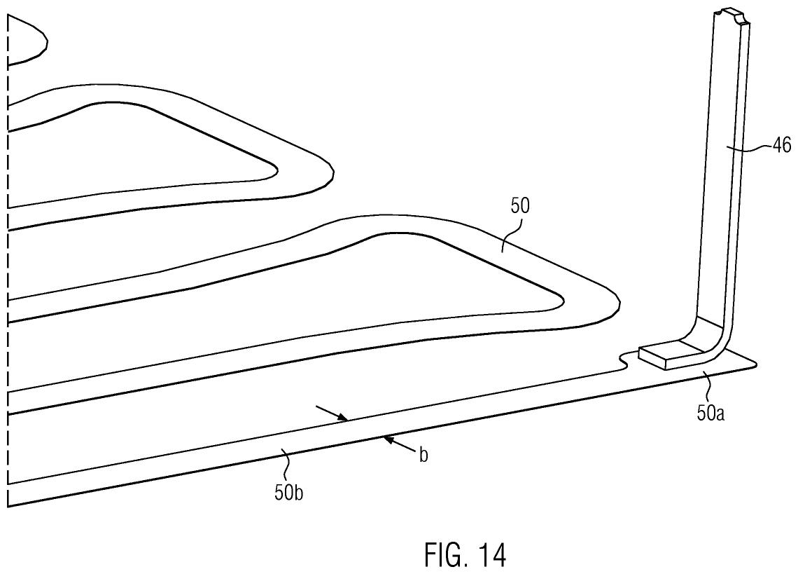

FIG. 14 shows an embodiment of an end region of flat conductor 50 in which flat conductor 50 is connected to an electrical contact 46, presently an angled contact member 46. It can be seen that end section 50a of flat conductor 50 has a larger cross section or a greater width b than the other, central sections 50b of flat conductor 50. This measure ensures that end section 50a has a lower electrical resistance and therefore generates less heat than central regions 50b of flat conductor 50. For the same purpose, the thickness of contact 46 is considerably greater than the thickness of flat conductor 50 in order to likewise reduce the generation of heat in the end region of flat conductor 50.

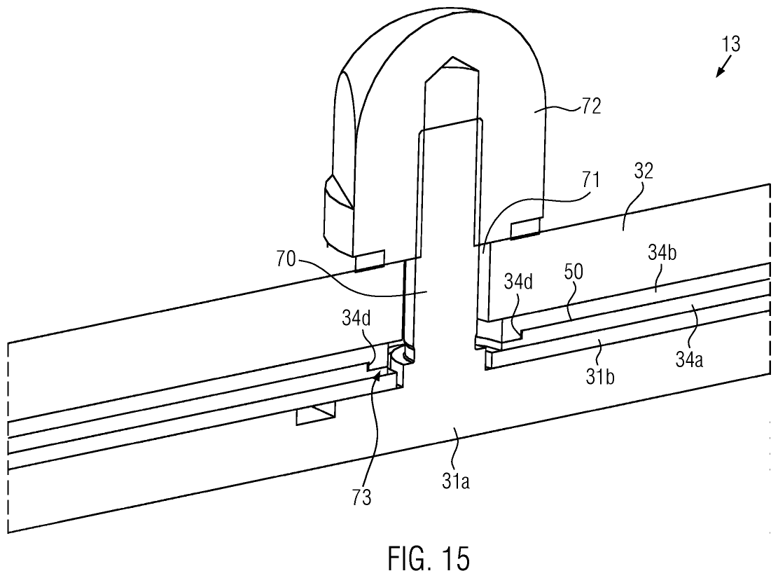

FIG. 15 shows a detail of an embodiment of heating assembly 13 with a flat conductor 50 as resistance heating element 30. Flat conductor 50 is sandwiched between a first and a second carrier 34a, 34b, for example, as shown in FIG. 13. An intermediate plate 31b, for example, made of aluminum, is arranged between first carrier 34a and an outer heating plate 31a. A clamping plate 32 is disposed on the side of second carrier 34b facing away from heating plate 31a.

A screw connection 70 connected to heating plate 31a, for example, a threaded bolt 70, passes through an opening 71 in clamping plate 32, in carriers 34a, 34b, and intermediate plate 31b. A cap nut 72 is placed on screw connection 70 and tightened so tightly that it exerts a force on clamping plate 32 which in turn presses the sandwich-like structure of heating assembly 13 against one another. Screw connection 70 can be welded to heating plate 31a.

FIG. 15 further shows an electrical insulation 73 of screw connection 70 from flat conductor 50. In the embodiment illustrated, electrical insulation 73 is achieved by a shoulder 34d of two carriers 34a, 34b. Shoulder 34d ensures that the region of flat conductor 50 is not exposed to opening 71 through which screw connection 70 passes. Electrical insulation 73 prevents an electrical flashover between flat conductor 50 and screw connection 70.

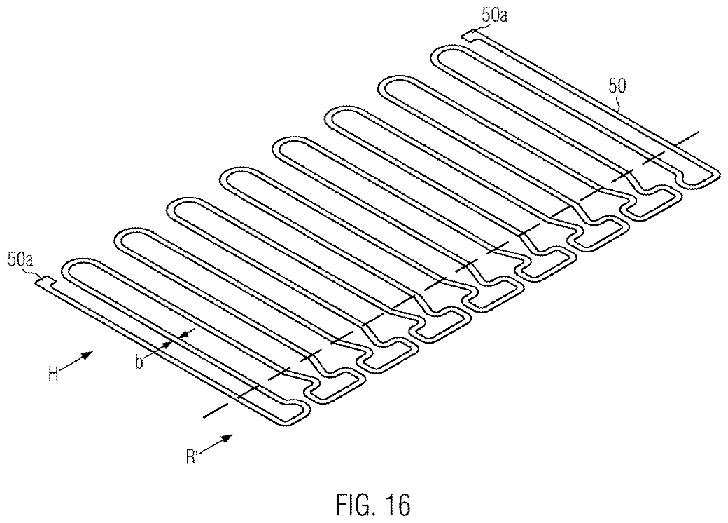

FIG. 16 shows a perspective view of a further embodiment of an electrical flat conductor 50. This flat conductor 50 also runs in a substantially meandering manner. The flat electrical conductor 50 can have a conductor track width b of preferably 2.5 mm to 30 mm, and a thickness (perpendicular to the plane of the flat conductor) in the range of 10 μm to 70 μm. In the embodiment example according to FIG. 16, the resistance heating element 30 realized in the form of an electrical flat conductor 50 has a main region H and an edge region R′. In the main region H, which occupies the majority of the area of the resistance heating element 30, the tracks of the flat conductor 50 have a U-shaped course. In the edge region R′, on the other hand, which may have a width of, for example, 15 mm to 75 mm, the course deviates from a U-shaped course. As a result, a larger proportion of the area of the heating element 30 is taken up by the flat conductor 50 in the edge region R′ than in the main region H. The heating power generated per area (e.g., per unit of area) in the edge region R′ is correspondingly greater, namely by a factor of, for example, 1.1 to 2.0, compared to the heating power per area (e.g., per unit of area) in the main region H. In this way, higher heat losses at the edge region R′ can be compensated.

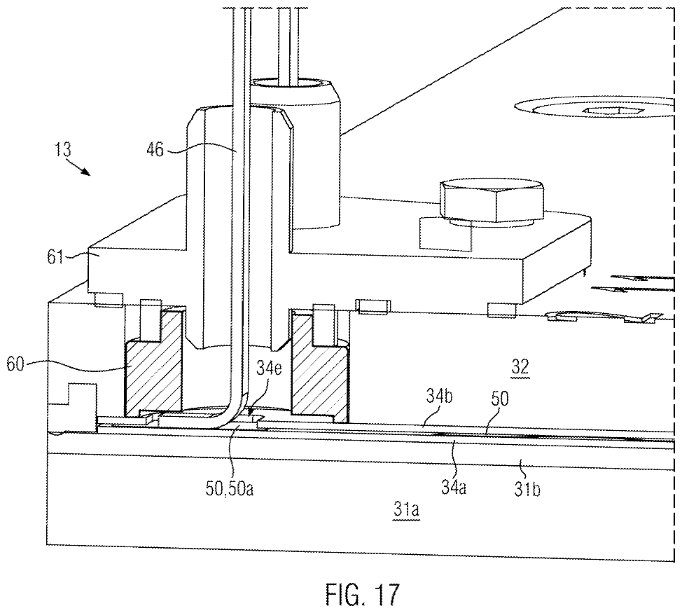

FIG. 17 shows a perspective view of an embodiment of a heating assembly or arrangement 13 cut open in the vertical direction. An outer heating plate 31a, for example made of aluminum, is used to transfer heat through its underside to a work piece, for example packaging material. An intermediate plate 31b, for example also made of aluminum, rests on the opposite upper side of the heating plate 31a. On this intermediate plate 31b, there is, in turn, a plate-shaped insulator or carrier 34a, for example made of Micanite. The electrically conductive flat conductor heating element 50 is located on this insulator or carrier 34a, or in channels or recesses in the insulator/carrier 34a. An angled contact member or contact piece 46 with a considerably greater material thickness than the flat conductor 50 is welded to an end region 50a of the electrical flat conductor 50 and in this way electrically connected to the flat conductor 50. The angled contact member 46 is used to make electrical contact with the flat conductor 50.

A terminal plate or clamping plate 32 is located on the side of the flat conductor opposite the heating plate 31a. Between the clamping plate 32 and the flat conductor 50 is a second insulator or carrier 34b which, like the first insulator 34a, is plate-shaped and may also be made of Micanite or comprise Micanite. The angled contact member 46 passes through an opening 34e in the second insulator 34b.

In its lower region adjacent to the flat conductor 50, the angled contact member 46 is surrounded by an electrically insulating, temperature-resistant bushing 60, for example made of PEEK. It serves, among other things, to electrically insulate the terminal plate 32 from the angled contact member 46. Placed on the terminal plate 32, screwed to it and projecting into the bushing 60, the heating arrangement 13 has a connecting bushing 61. This is electrically insulating, heat-resistant up to temperatures of at least 250° C. or even at least 300° C. and may also be formed from PEEK. In addition to electrical insulation, it also serves as mechanical insulation or for mechanical protection of the angled contact member 46.

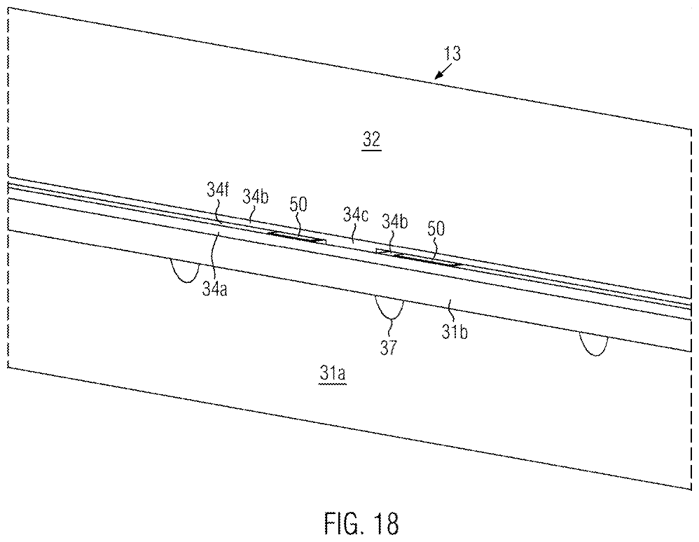

FIG. 18 shows a perspective view of an enlarged section of a vertically cut open heating assembly or arrangement 13. The tracks of the flat electrical conductor 50 are located on the upper side of the first insulator or carrier 34a. They may have been produced by applying a full-surface layer of the material of the flat conductor 50 to the surface of the carrier 34a, for example by bonding. The bonding may be achieved by providing an adhesive (e.g. an adhesive layer), or by generating bonding forces during the manufacturing of the carrier 34a. Subsequently, the contours of the later flat conductor 50 have been milled or punched out of the layer before excess portions between the conductive tracks have been peeled off or otherwise removed.

The second insulator 34b is arranged on the opposite side of the flat conductor 50 to the first insulator 34a. It can be made of the same material, for example Micanite. Between the individual conductive paths of the electrical flat conductor 50 and/or between different heating circuits or heating areas, the second insulator/support 34b has webs 34c. These webs 34c serve to insulate adjacent conductive paths of the flat conductor 50 and/or different heating circuits from one another in such a way that no electrical flashover is possible even under vacuum conditions. Adjacent to a web 34c is a pocket or “nest” 34f in which the flat electrical conductor 50 is disposed. The pocket or nest 34f may have a depth of about 0.05 mm to 0.5 mm and may be formed in the plate-shaped insulator 34b by milling. In the pocket 34f, the flat electrical conductor 50 has sufficient space to deform without generating thermal stresses during heating or cooling. On its side facing the heating element 30, the outer heating plate 31a has at least one vacuum channel 37. Both in the embodiment of FIG. 3, and in the embodiment of FIG. 18, the outer heating plate 31a can optionally be separable from the other components of the heating assembly 13. This allows, e.g., to treat the outer heating plate 31a separably from the other components of the heating assembly 13, for example, in order to renew or replace a layer of Teflon on a surface of the heating plate 31a facing the workpiece.

Based on the embodiments illustrated, the workstation according to the disclosure and the method according to the disclosure can be amended in many ways. For example, other materials are conceivable or the profile of flat conductor 50 can under certain circumstances differ considerably from the profile shown in FIG. 9, 10 or 16, for example, comprise more or fewer turns.

What is claimed is:

1. A workstation for a film-processing packaging machine, wherein the workstation defines a film transport plane in which the packaging film can be transported, and the workstation comprises an electrically operable heating assembly,
wherein the heating assembly comprises a heating plate, a clamping plate and an electrically conductive planar resistance heating element arranged between the heating plate and the clamping plate, and wherein the resistance heating element in each of two directions spanning a plane parallel to the film transport plane has a dimension that is greater by a factor of at least 100 than a dimension in a direction perpendicular to the film transport plane.

2. The workstation according to claim 1, wherein an electrically insulating insulator is arranged between the resistance heating element and the heating plate and/or between the resistance heating element and the clamping plate.

3. The workstation according to claim 1, wherein a thickness of the heating assembly from an upper edge of the clamping plate to a lower edge of the heating plate is 6 to 26 mm.

4. The workstation according to claim 3, wherein the thickness of the heating assembly from the upper edge of the clamping plate to the lower edge of the heating plate is in the range of 8 to 15 mm.

5. The workstation according to claim 1, wherein the resistance heating element has an area of 5,000 to 1,500,000 mm².

6. The workstation according to claim 1, wherein the resistance heating element comprises a layer of a heating varnish.

7. The workstation according to claim 6, wherein the layer of the heating varnish has a thickness of 15 μm to 250 μm and/or a specific resistance of 100 to 1,400 Ω*mm²/m.

8. The workstation according to claim 6, wherein the layer of the heating varnish has a specific resistance in a range of 200 to 1,000 Ω*mm²/m.

9. The workstation according to claim 6, wherein a plurality of weak points is provided in the heating varnish.

10. The workstation according to claim 9, wherein the plurality of weak points comprises openings or points with a reduced layer thickness of the heating varnish.

11. The workstation according to claim 1, wherein the resistance heating element comprises an electrical flat conductor having a meandering profile arranged in a plane.

12. The workstation according to claim 11, wherein the flat conductor has a specific resistance of at least 0.45 Ω*mm²/m.

13. The workstation according to claim 12, wherein the specific resistance is at least 0.7 Ω*mm²/m.

14. The workstation according to claim 11, wherein the flat conductor comprises stainless steel, a chromium-nickel alloy, constantan, or graphite.

15. The workstation according to claim 11, wherein an end section of the flat conductor has a larger cross section than a central section of the flat conductor.

16. The workstation according to claim 11, wherein the flat conductor has a thickness in a range from 10 μm to 70 μm.

17. The workstation according to claim 11, wherein the flat conductor has a width in a range from 1.5 mm to 30 mm.

18. The workstation according to claim 1, wherein the heating plate comprises an intermediate plate and an outer heating plate, the intermediate plate is arranged between the outer heating plate and the resistance heating element, and the outer heating plate on its surface facing the resistance heating element comprises at least one vacuum channel which is connected to vacuum openings and covered by the intermediate plate.

19. The workstation according to claim 18, wherein a temperature sensor is arranged on the surface of the outer heating plate facing the resistance heating element.

20. The workstation according to claim 1, wherein the workstation is configured as a forming station, as a preheating station, as a labeling station, as a labeling printing station, or as a sealing station for processing a packaging film.

21. The workstation according to claim 1, wherein a thermal mass of the heating plate at least substantially corresponds to a thermal mass of the clamping plate.

22. A packaging machine comprising the workstation according to claim 1.

23. A method for operating the workstation according to claim 1, wherein the heating plate of the workstation is made to contact the packaging film intermittently, the resistance heating element is supplied with a current pulse at least over a defined time interval prior to each contact between the heating plate and the packaging film to increase temperature of the heating plate.

24. The method according to claim 23, wherein the temperature of the heating plate is kept constant at least temporarily during contact between the heating plate and the packaging film.

25. A method of manufacturing an electrical heating element for a work station for a film-processing packaging machine, the method comprising:
applying a flat conductor layer to a carrier;
contouring the flat conductor layer by milling or cutting to form a strip-shaped flat conductor; and
stripping off regions of the flat conductor layer between strips of the flat conductor.

26. The method according to claim 25, wherein the flat conductor layer is applied to the carrier by bonding.

27. The method according to claim 25, wherein the flat conductor layer comprises stainless steel or another conductive metal.
